(19) United States
(12) Patent Application Publication
(10) Pub. No.: US 2011/0248594 A1
(43) Pub. Date: Oct. 13, 2011

(54) Electrical Machine and Permanent-Magnet

(76) Inventor: Arwyn Thomas, Brithdir (GB)

(21) Appl. No.: 13/083,686

(22) Filed: Apr. 11, 2011

(30) Foreign Application Priority Data
Apr. 13, 2010 (EP) 10159767.2

(51) Int. Cl. H02K 21/12

(52) U.S. Cl. 310/156.46

(57) ABSTRACT

An electrical machine including a permanent magnet and a coil is provided. The coil is arranged to interact with the permanent magnet via an air gap, which located between the two. The permanent magnet includes a surface, which is aligned to the coil and to the air gap so that that magnetic forces of the permanent magnet interact via the surface and the air gap with the coil by a magnetic flux density distribution. The surface has a cross-section having a shape that approximates at least partly to a sinusoidal function, causing the magnetic flux distribution in the air gap to be substantially sinusoidal.

### CROSS REFERENCE TO RELATED APPLICATIONS

This application claims priority of European Patent Office application No. 10159767.2 EP filed Apr. 13, 2010, which is incorporated by reference herein in its entirety.

### FIELD OF INVENTION

The invention relates to an electrical machine, which contains permanent magnets and to the permanent magnets being used. The invention especially relates to a synchronous machine.

### BACKGROUND OF INVENTION

An electrical machine like a generator contains a number of permanent magnets, which interact with at least one coil to generate electrical power. For the magnets used a compromise needs to be found. It is necessary to minimize or even avoid at least some of the following problems:

First of all the magnetic force (magnetic field-strength) of the magnets will vary due to their individual characteristics and tolerances. Periodical torque pulsations will occur if the machine is within the status “no-load”, “idling” or “full load”.

Next the number and/or the size of used permanent magnets needs to be minimised due to the steadily increasing costs.

The torque stated above is denoted as “cogging torque” if the machine is in “no-load”-status, while it is denoted as “ripple torque” if the machine is “load”-status.

The torque pulsations may result in vibrations, which propagates inside the machine and within a used supporting structure of the machine also. The torque pulsations may harm mechanical and electrical components.

Furthermore the torque pulsations may generate acoustic noise with low frequencies. The frequencies are audible and thus disturb the environment, the human-beings and the wild-life.

Especially if a huge direct drive generator is within a wind turbine the disturbance needs to be reduced or even avoided.

Several techniques are known to reduce “cogging torque” or “ripple torque”. For example the permanent magnets are shaped specifically or so called “dummy slots” are used inside the electrical machine.

The magnet shaping is advantageous for a given current and a required torque. The magnet shaping can be done in regard to minimize the amount of magnet material needed.

It is also possible to reduce cogging-torque and/or ripple-torque by an optimized shaping of the magnets.

A huge number of optimized magnet-shapes is known in the prior art.

An important and commonly applied one shows upper magnet corners, which are cut away. This is called chamfering. The chamfer angle used may be 45° but also alternative chamfer angles are known in the prior art. However this kind of chamfering does not reduce the cogging-torque and the ripple-torque to a satisfactory level.

Document EP 1 076 921 A1 describes a magnet piece with a cross sectional geometry. The geometry corresponds to the half-cycle arc of a sine curve. It is very difficult and expensive to manufacture this geometry. Even this approximation does not reduce the cogging-torque and the ripple-torque to a satisfactory level.

### SUMMARY OF INVENTION

It is therefore the aim of the invention to provide an improved permanent magnet to address the problems mentioned above, and to provide an electrical machine, which contains this type of improved permanent magnet.

This aim is reached by the features of the independent claims

Preferred configurations are object of the dependent claims.

According to the invention the electrical machine contains a permanent magnet and a coil. The magnet and the coil interact with the permanent magnet via an air gap, which is located between the permanent magnet and the coil.

The permanent magnet and the coil are arranged in a way that electrical power is generated in the coil when the permanent magnet or the coil is moved in their relative position to each other.

The permanent magnet contains a surface, which is aligned to the coil and to the air gap in a way, that magnetic forces of the permanent magnet interact via the surface and the air gap with the coil by a magnetic flux density distribution.

The cross sectional shape of this surface approximates at least partly to a sinusoidal-function.

Preferably this function is used as sinusoidal-function:

(m*sin(theta))+(hₘ*w_{ft}).

The parameters used are defined as:
m modulation index; 0<m<1: the modulation index is used to control an amplitude of the sin-function;
w_{ft} control-value; 0<w_{ft}<1: this value is used to control a “flat top ratio”-width. The control-value is assigned to the axis where the sin-function oscillates and thus the width of the flat-top is controlled.
hₘ total height of the magnet;
m_{w} width of the magnet; and
theta angle, preferably set to π/2 for a half period of a sinusoid—other values might be chosen.

Due to these features a substantially sinusoidal flux density distribution in the air gap and across slots, being used to support the coil, is obtained.

According to the invention a level of modulation is achieved. The modulation level is varied by the parameter “m” as defined above. This allows modulation of the flux density distribution, even within the air gap.

The optimized shape of the magnet is modified by the factor “hₘ*w_{ft}” as defined above. This leads to a flat top of the magnet, being aligned and adjacent to the air gap.

This flat top increases the flux density distribution asides the coil, as a longer part of the magnet surface is kept near to the stator relatively.

The magnet typically shows a rectangular area, which is located opposite to the shaped surface. The rectangular area results in a base-line within the cross-sectional view of the magnet.

For the surface-optimisation a number of system-parameters should be taken into account—the optimisation should be done in view of:
a reduced magnet volume within the machine,
a reduced togging torque,
reduced harmonics,
an improved torque,
an increased flux density,
an increased efficiency of the machine, . . . , etc.

Due to the function defined above the best compromise between magnet volume, machine efficiency, cogging torque, cogging ripple, demagnetization etc. can be found by an iterative adjustment of a few parameters only. The optimisation is thus fast and effective.

A number of design constraints are given usually due to the overall machine layout: size, magnet foot print, minimum air gap distance, torque, efficiency, . . . , etc.

This number of constraints reduces the complexity of the iterative optimization, too.

The invention is applicable to radial, axial and linear magnetic geometries, even if the permanent magnet moves relative to a “slotted stator”-geometry, for example.

Thus a sinusoidal air gap flux density is provided, reducing the cogging forces between the stator and the magnet pole.

### BRIEF DESCRIPTION OF THE DRAWINGS

The invention is shown by help of some drawings now. The drawings show preferred configurations and do not limit the scope of the invention.

FIG. 1 shows a cross-sectional view of a permanent magnet PM1, which is shaped according to the invention,

FIG. 2 shows a perspective view of the permanent magnet PM1, referring also to FIG. 1,

FIG. 3 shows the permanent magnet of FIG. 1 and FIG. 2 with a sinusoidal-shaped surface, while

FIG. 4 shows a method for the design and for the optimisation of the shaped surface according to the invention.

### DETAILED DESCRIPTION OF INVENTION

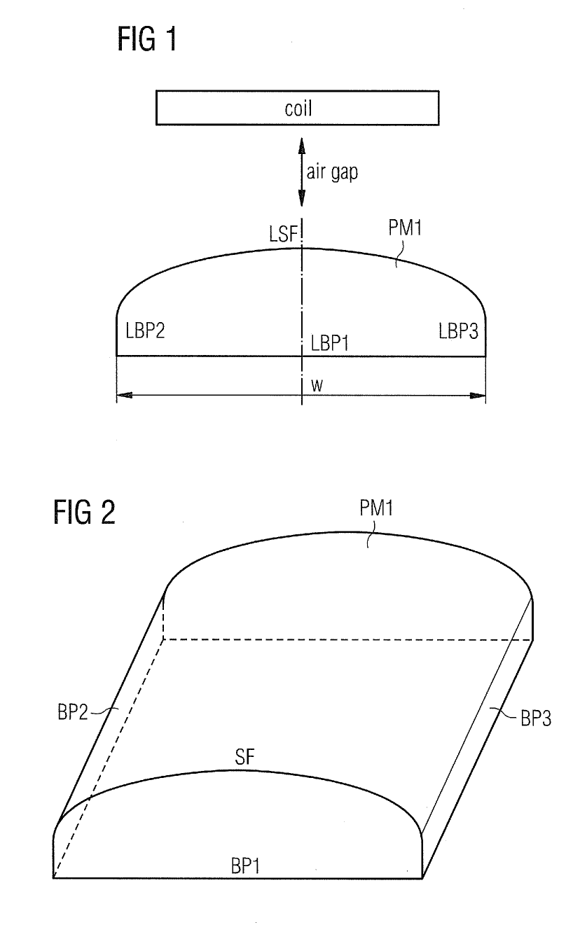

FIG. 1 shows a cross-sectional view of a permanent magnet PM1, which is shaped according to the invention.

The cross section of the permanent magnet PM1 contains three linear sections LBP1, LBP2, LBP3. These sections LBP1, LBP2, LBP3 may belong to rectangular areas BP1, BP2, BP3 as shown in FIG. 2 later.

The cross section of the permanent magnet PM1 contains also a line LSF. The line LSF is shaped in a way, that it approximates at least partly to a sinusoidal-function. It preferably approximates the function also defined above:

(m*sin(theta))+(hₘ*w_{ft}).

The surface line LSF belongs to a shaped surface SF of the permanent magnet PM1 as shown in FIG. 2 later.

The shaped surface (FIG. 2: SF) is aligned to a coil and to an air gap, which is between the permanent magnet PM1 and the coil.

FIG. 2 shows a perspective view of the permanent magnet PM1, referring also to FIG. 1.

Due to the shaped surface SF a smooth transition at the end points of the magnet PM1 near the base areas or base planes BP2 and BP3 is achieved.

The base planes BP2 and BP3 are orthogonal to the base plane BP1 of the permanent magnet PM1.

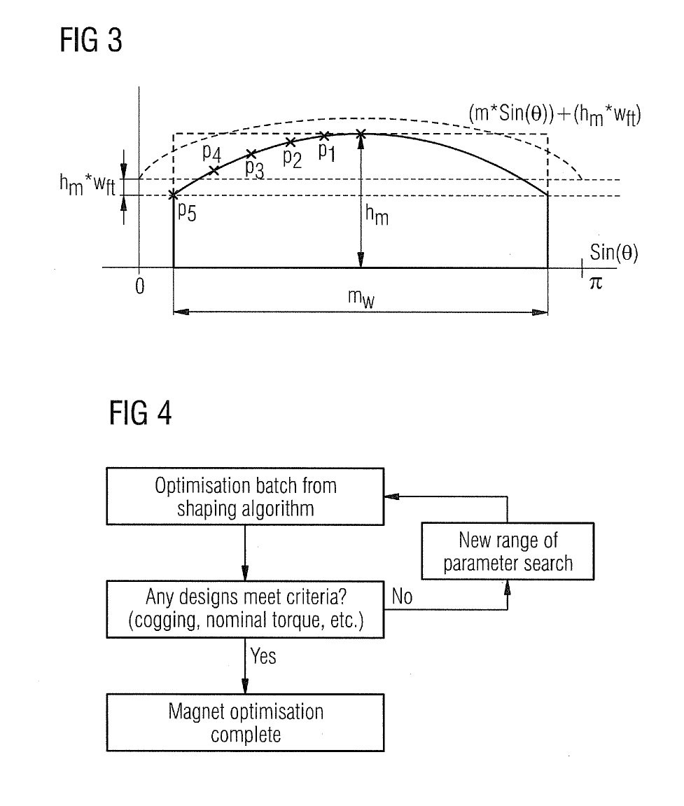

FIG. 3 shows the permanent magnet of FIG. 1 and FIG. 2 with an optimized sinusoidal-shaped surface.

As defined above the sinusoidal-function is calculated preferably according to the function:

(m*sin(theta))+(hₘ*w_{ft}).

The parameters are defined as:
m modulation index; 0<m<1: the modulation index is used to control an amplitude of the sin-function;
w_{ft} control-value; 0<w_{ft}<1: this value is used to control a “flat top ratio”-width. The control-value is assigned to the axis where the sin-function oscillates and thus the width of the flat-top is controlled.
hₘ total height of the magnet;
m_{w} width of the magnet; and
theta angle, preferably set π/2 for a half period of a sinusoid—other values might be chosen.

Due to these features a substantially sinusoidal flux density distribution in the air gap and across slots, being used to support the coil, is obtained.

According to the invention a level of modulation is achieved. The modulation level is varied by the parameter “m” as defined above.

This allows a modulation of the flux density distribution, even within the air gap.

The optimized shape of the magnet is modified by the factor “hₘ*w_{ft}” as defined above.

This leads to a flat top of the magnet, being aligned and adjacent to the air gap.

This flat top increases the flux density distribution asides the coil, as a longer part of the magnet surface is kept near to the stator relatively.

A number of discrete points P1, P2, . . . , P5 is determined. The points describe an approximation of a sinusoid.

The discrete points P1, . . . , P5 provide a more simple optimized shape of the magnet surface SF, providing the coordinates for the surface geometry.

Preferably the shape of the magnet/surface is determined by help of a numerical design or iteration or by other analytical methods.

An optimized magnet shape is determined by an appropriate number of points, which are chosen for this.

The sinusoidal function might be approximated by typically 6 up to 10 points for the surface. Even the modulating function and the lifting are chosen by a numerical or iterative solution.

Preferably adjacent points are interconnected by linear segments. Thus a chamfered magnet surface is achieved.

This results in an easy process of magnet-manufacturing.

FIG. 4 shows a simplified method for the design and for the optimisation of the shaped surface according to the invention.

The method comprises the steps of:
define a number of discrete points to approximate the function as defined above,
define the design criteria of the machine layout (such as magnet width mw, torque of the machine, minimum air gap distance, cogging torque, ripple torque, . . . , etc.
run of an optimization algorithm to optimize the magnet shape (by iteratively adjusting at least the modulation function m and/or the lifting (hₘ*w_{ft}) to find the magnet shape that meets all the criteria best.

1.-10. (canceled)

11. An electrical machine, comprising:
a coil; and
a permanent magnet, wherein the coil interacts with the permanent magnet via an air gap located between the coil and the permanent magnet, the permanent magnet comprising:
a surface aligned with respect to the coil and to the air gap such that magnetic forces of the permanent magnet interact via the surface and the air gap with the coil by a magnetic flux density distribution, the surface having a cross-section having a shape that approximates at least partly to a sinusoidal-function, causing the magnetic flux density distribution in the air gap to be substantially sinusoidal.

12. The electrical machine according to claim 11, wherein the sinusoidal function, to which shape of the cross-section of the surface approximates at least partly, is:
(m*sin(theta))+(hₘ*w_{ft}),
wherein,
m is defined as modulation index, wherein 0<m<1; and wherein the modulation index is used to control an amplitude of the sinusoidal function;
w_{ft} is defined as a control-value, wherein 0<w_{ft}<1, wherein the control value is assigned to an axis along which the sinusoidal function oscillates, wherein the control value is used to control a width of a flat-top of the permanent magnet, and wherein the flat top is adjacent to the air gap;
hₘ is defined as a total height of the permanent magnet;
m_{w} is defined as width of the permanent magnet; and
theta is defined as an angle.

13. The electrical machine according to claim 12, wherein the permanent magnet comprises a rectangular area opposite to the surface.

14. The electrical machine according to claim 12, wherein the cross-section of the surface is a line defined by a plurality of points, wherein at least two points of the plurality of points are interconnected by a linear segment.

15. An electrical machine, comprising:
a coil; and
a permanent magnet, wherein the coil interacts with the permanent magnet via an air gap located between the coil and the permanent magnet, wherein the permanent magnet and the coil are arranged in a way that electrical power is generated in the coil when the permanent magnet or the coil is moved in their relative position to each other, the permanent magnet comprising:
a surface aligned with respect to the coil and to the air gap such that magnetic forces of the permanent magnet interact via the surface and the air gap with the coil by a magnetic flux density distribution, the surface having a cross-section having a shape that approximates at least partly to a sinusoidal-function, causing the magnetic flux density distribution in the air gap to be substantially sinusoidal.

16. The electrical machine according to claim 15, wherein the sinusoidal function, to which shape of the cross-section of the surface approximates at least partly, is:
(m*sin(theta))+(hₘ*w_{ft}),
wherein,
m is defined as a modulation index, wherein 0<m<1; and wherein the modulation index is used to control an amplitude of the sinusoidal function;
w_{ft} is defined as a control-value, wherein 0<w_{ft}<1, wherein the control value is assigned to an axis along which the sinusoidal function oscillates, wherein the control value is used to control a width of a flat-top of the permanent magnet, and wherein the flat top is adjacent to the air gap;
hₘ is defined as a total height of the permanent magnet;
m_{w} is defined as a width of the permanent magnet; and
theta is defined as an angle.

17. The electrical machine according to claim 15, wherein the permanent magnet comprises a rectangular area opposite to the surface.

18. The electrical machine according to claim 15, wherein the electrical machine is selected from the group consisting: a synchronous machine, a radial flux machine, a linear flux machine and an axial flux machine.

19. The electrical machine according to claim 15, wherein the electrical machine is a generator of a wind turbine.

20. The electrical machine according to claim 15, wherein the cross-section of the surface is a line defined by a plurality of points.

21. The electrical machine according to claim 20, wherein at least two points of the plurality of points are interconnected by a linear segment.

22. The electrical machine according to claim 15, wherein the surface of the permanent magnet contains a flat top adjacent to the air gap.

23. A permanent magnet for an electrical machine, the electrical machine comprising a coil and the permanent magnet, wherein the coil interacts with the permanent magnet via an air gap located between the coil and the permanent magnet, the permanent magnet comprising:
a surface aligned with respect to the coil and to the air gap such that magnetic forces of the permanent magnet interact via the surface and the air gap with the coil by a magnetic flux density distribution, the surface having a cross-section having a shape that approximates at least partly to a sinusoidal-function, causing the magnetic flux density distribution in the air gap to be substantially sinusoidal.

24. The permanent magnet according to claim 23, wherein the sinusoidal function, to which shape of the cross-section of the surface approximates at least partly, is:
(m*sin(theta))+(hₘ*w_{ft}),
wherein,
m is defined as a modulation index, wherein 0<m<1; and wherein the modulation index is used to control an amplitude of the sinusoidal function;
w_{ft} is defined as a control-value, wherein 0<w_{ft}<1, wherein the control value is assigned to an axis where the sinusoidal function oscillates, wherein the control value is used to control a width of a flat-top of the permanent magnet, and wherein the flat top is adjacent to the air gap;
hₘ is defined as a total height of the permanent magnet;
m_{w} is defined as a width of the permanent magnet; and
theta is defined as an angle.

25. The permanent magnet according to claim 24, wherein the cross-section of the surface is a line defined by a plurality of points, wherein at least two points of the plurality of points are interconnected by a linear segment.
